(19) United States
(12) Patent Application Publication
(10) Pub. No.: US 2013/0318516 A1
(43) Pub. Date: Nov. 28, 2013

(54) COMPUTER SYSTEM FIRMWARE UPDATE

(71) Applicant: Edward D. Knapton, Spring, TX (US)

(72) Inventor: Edward D. Knapton, Spring, TX (US)

(21) Appl. No.: 13/981,904

(22) PCT Filed: Apr. 29, 2011
(86) PCT No.: PCT/US2011/034673

§ 371 Date: Jul. 25, 2013

(51) Int. Cl. G06F 9/445

(52) U.S. Cl. CPC G06F 8/65
USPC 717/168

(57) ABSTRACT

Techniques to update firmware include an input sensor to provide a signal and a processor to execute an update program to initiate update of firmware, if the signal is provided from the input sensor and the processor does not provide the signal from execution of the instructions of the update program.

### BACKGROUND

Some computer systems, such as laptop or notebook computers, may contain firmware which refers to software instructions for controlling the operation of hardware components associated with the computer systems. For example, some computer systems may include non-volatile storage medium for storing a basic input/output system (BIOS) which includes software instructions to check that hardware components within the computer systems are working property. There are occasions in which it may be desirable to update firmware such as when a new version of the firmware is released to correct problems or improve operation.

### BRIEF DESCRIPTION OF THE DRAWINGS

FIG. 1 is a block diagram of an example computer system to update firmware.

FIG. 2 is a perspective view of an example computer system to update firmware.

FIG. 3 is a perspective view of another example computer system to update firmware.

FIG. 4 is an example of a flow diagram illustrating a method to update firmware on a computer system.

### DETAILED DESCRIPTION

As explained above, some computer systems, such as laptop or notebook computers, may contain firmware. Such firmware can be referred to as software instructions for controlling the operation of hardware components associated with the computer systems. For example, some computer systems may include non-volatile storage medium for storing a basic input/output system (BIOS) which can include software instructions to check that hardware components within the computer systems are working properly. There are occasions in which it may be desirable to update firmware such as when a new version of the firmware is released to correct problems or improve operation.

However, problems may be encountered when updating firmware on computer systems. For example, a user may receive a firmware update program to update firmware on computer systems. However, it may be difficult to verify the authenticity of the source of the update program and the program may proceed to update the firmware even though it was not authorized to perform the update. This update program may be an unauthorized program and may introduce undesirable code into the firmware such as a virus which may destroy data on the computer systems or otherwise render the computer systems inoperable. Therefore, it may be desirable to develop techniques for improving the authentication and verification process of updating firmware on computer systems.

The present application in some examples may provide techniques to help address problems related to authentication and verification of updating firmware on computer systems. For example, the present application describes a computer system with a means of requiring user input to enable a firmware update program to proceed to update firmware on the computer system. In one example, a computer system can be configured with a processor to execute a firmware update program, if a signal is provided from an input sensor, to initiate update of firmware wherein the processor does not provide the signal from execution of the update program. In other words, the firmware is updated if the user causes the input sensor to generate a signal as a result of the user activating the sensor. The input signal is generated by hardware and not by software by the processor executing software instructions; because a signal generated by execution of software could be generated by unauthorized software. The input sensor can detect the presence of the user and the computer can check this signal before it proceeds to update the firmware.

In one example, the computer system can be a laptop computer with a display member rotatably coupled to a base member. The computer system can include an input sensor that can detect the relative position of the display member to the base member and can detect when the computer system is in the closed position, that is, when the computer display member and the base member are in close proximity or in a predefined position to each other. The computer system can prompt the user to place the computer system in the dosed position which can allow the computer system to proceed to update the firmware. The computer system will not update firmware while the computer system is in the open position; it requires the user to place the computer system in the closed position. That is, it requires the user to take some action before the computer system can proceed to update the firmware. Therefore, these techniques require input from a user before updating the firmware which may help reduce the likelihood of unauthorized firmware updates.

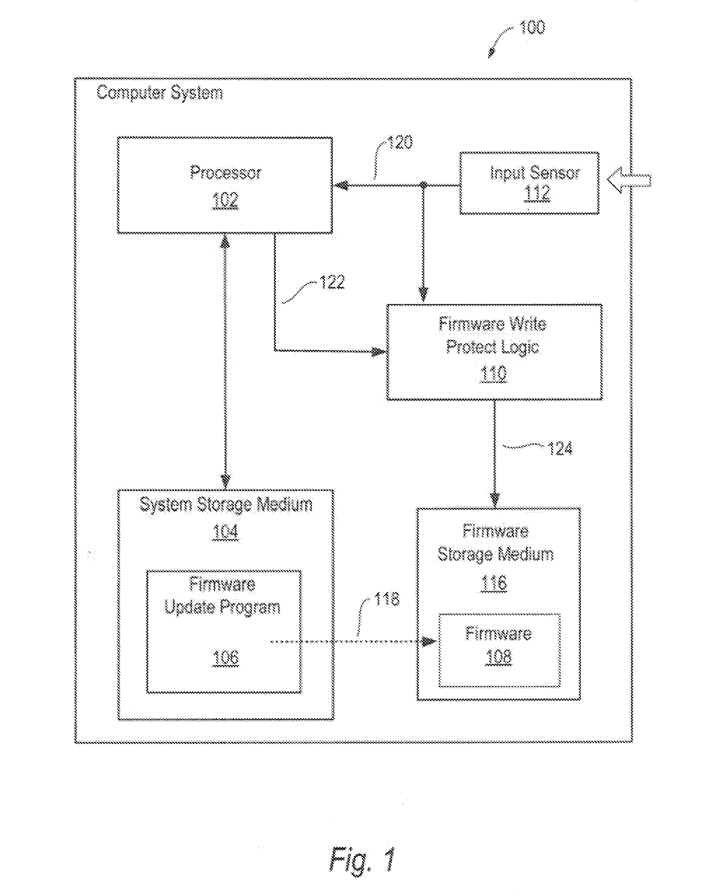

FIG. 1 is a block diagram of an example computer system 100 to update firmware 108 on the computer system based on input from an input sensor 112. The computer system 100 includes firmware storage medium 116 can store firmware 108 which may include software instructions executable by processor 102 to manage hardware components of the computer system. The computer system 100 includes system storage medium 104 to store a firmware update program 106 which can include software instructions executable by processor 102 to update firmware 108 with firmware from the update program as shown by dashed arrow 118.

The input sensor 112 can be any sensor device that can generate an input signal 120 in response to detection of the physical presence of a user. For example, input sensor can be any sensor device that requires a user to take some action to activate the sensor. In one example, computer system 100 can be a laptop computer with a display member rotatably coupled to a base member. In this case, the input sensor 112 can be a switch which can detect the position of the display member relative to the base member. The input sensor 112 can generate input signal 120 indicating when the laptop has been placed in a closed position (or a predetermined relative position) by a user. As explained in further detail below, computer system can be configured to update firmware 108 when the computer system 100 is placed in the closed position by the user. The computer system 100 can be prevented from updating firmware 108 when the computer system is in the open position.

The input signal 120 is shown as being fed to both processor 102 and firmware write protect logic 110. The processor 102 generates a write signal 122 directed to write protect logic 110 indicating that the processor desires to write to firmware storage medium 116 and firmware 108. The firmware write protect logic 110 generates a write enable signal 124 directed to firmware storage 116 to enable processor 102 to initiate update of firmware 108. The write enable signal 124 can be generated based on input signal 120 (which indicates the presence of a user or activation of the sensor by a user) and write signal 122 (which indicates that processor 102 desires writing to firmware storage medium 116).

As explained below in further detail, processor 102 can execute instructions of update program 106 to initiate update of firmware 108 if input sensor 112 generates input signal 120 based on user activation of the input sensor. That is, input signal 120 can be generated as a result of the physical presence of the user and not by the processor executing instructions of a program. The update program 106 can check for the presence of input signal 120 before proceeding to initiate the update of firmware 108. In other words, computer system 100 initiates update of firmware 108 when a user causes a signal to be generated from the input sensor and not as result of the processor executing the instructions of update program, as explained below in further detail. These techniques require user input before the update of firmware can occur which may reduce likelihood of unauthorized firmware updates.

As explained above, update program 106 can check for the presence of input signal 120 before proceeding to initiate the update of firmware 108. In another example, update program 106 can initiate update of firmware without checking for the presence of input signal 120. In this case, update program 106 can initiate the update of firmware 108 by starting to copy or write a portion of the new firmware from the update program 106 to firmware 108. The update program 106 can check whether the update was successful by verifying whether firmware 108 was updated by reading back the portion that was written. This example relies on using write protect logic 110 and whether input signal 120 has been generated. If input signal 120 was not generated, then write enable signal 124 is not enabled which prevents computer system 100 from performing a write operation to firmware 108 and therefore prevent an update to firmware 108. On the other hand if input signal 120 was generated, then write enable signal 124 is enabled which allows computer system 100 to perform a write operation to firmware 108 and therefore update firmware 108.

Although not shown, computer system 100 can include other hardware components such as a keyboard, a hard disk drive, a graphics video controller, a audio controller, a display device, a communication system and other components for operation of the computer system.

Although not shown, system storage medium 104 may include other programs or applications having instructions executable by processor 102 to control the operation of computer system 100. For example, system storage 104 may store an operating system (OS) which can include instructions when executed by the processor to control the operation of computer system 100. The OS (not shown) may include software (programs and data) that can manage computer hardware components and provide common services for execution of various application programs. In one example, the OS can be stored on a hard disk drive or other storage device and then loaded into system storage 104 after the completion of the execution of firmware 108. Although a single storage medium component 104 is shown, it should be understood that more than one memory component may be employed by computer system 100.

The firmware 108 can include software instructions for controlling the operation of hardware components, such as a display device, associated with computer system 100. For example, firmware 108 can be a basic input/output system (BIOS) which can include software instructions to check that hardware components within the computer system are working properly. Likewise, although a single firmware storage medium component 116 is shown, it should be understood that more than one memory component may be employed by computer system 100. The memory components 104 and 116 can comprise computer-readable medium such as volatile memory (e.g., random access memory, etc.), non-volatile storage (e.g., read only memory, Flash memory. CD ROM, etc.), and combinations thereof.

The processor 102 can be any hardware or logic configured to execute software instructions. Although a single processor 102 is shown, it should be understood that more than one processor may be employed by computer system 100. For example, computer system 100 may include a processor for controlling the overall operation of the device and a keyboard controller for controlling the operation of the keyboard. The keyboard controller can be a device which interfaces a keyboard to the computer system.

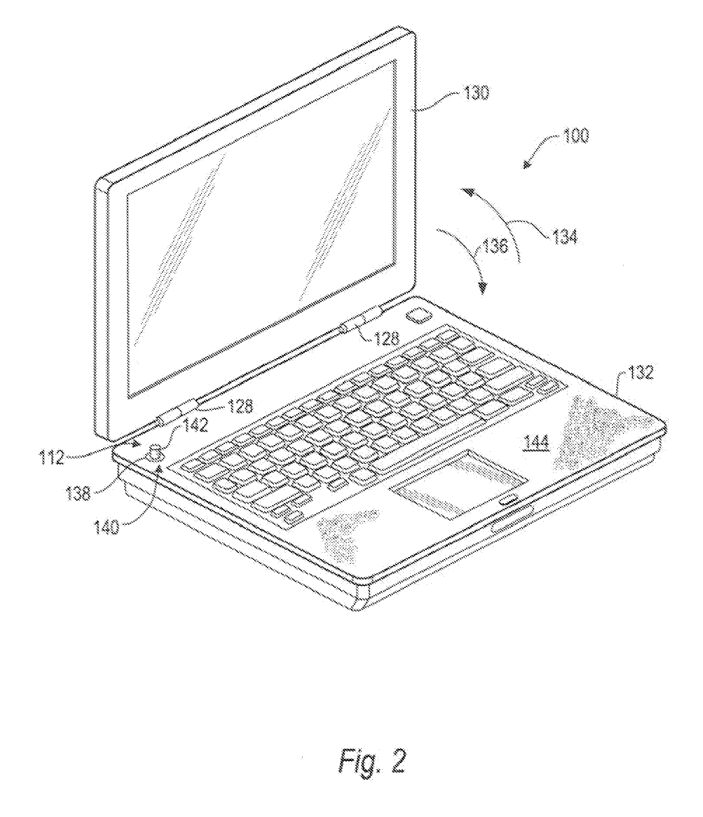

FIG. 2 shows a perspective view of an example computer system 100 of FIG. 1. In the example illustrated in FIG. 2, computer system 100 comprises a laptop or notebook computer. However, it should be understood that computer system 100 may comprise other types of computer devices such as, but not limited to, tablet personal computers, mobile phones and other types of portable and/or handheld computing devices. In the example illustrated in FIG. 1, computer system 100 comprises a display member 130 rotatably coupled to a base member 132 by hinges 128. The components of computer system 100 shown in FIG. 1 can be disposed in base member 132, display member 130 or a combination thereof.

In the example illustrated in FIG. 2, computer system 100 shows an input sensor 112 which can be used to detect the presence of a user and to generate input signal 120 (FIG. 1) in response thereto. The input sensor 112 requires a user to some take action to activate the sensor for the sensor to generate signal 120. As explained below, to allow computer system 100 to update firmware, a user can rotate display member 130 relative to base member 132 to activate input sensor 112. The input sensor 112 comprises a switch 140 for detecting a position of display member 130 relative to base member 132. The switch 140 comprises a depressable button 142 biased to extend at least partially upward through an opening 138 on a working surface 144 of base member 132 and retract at least partially into base member 132 in response to contact therewith by display member 130 (e.g., contact resulting from display member 130 being moved from an open position as illustrated in FIG. 2 toward and/or into a closed position relative to base member 132 as generally shown by arrow 136). However, it should be understood that button 142 may be otherwise located (e.g., elsewhere on working surface 144, a reversed position where button 142 is located on display member 130, etc.). Further, it should be understood that other devices and/or mechanisms may be used instead of button 142 (e.g., a contact element, mechanical toggle, etc.).

The computer system 100 can employ input sensor 112 to detect the presence of a user and, in response, to allow firmware to be updated. For example, in operation, computer system 100 can execute instructions of firmware update program 106 which can provide a prompt to a display of display member 130 to request whether a user desires to update firmware 108. The prompt may instruct the user to place the laptop in the dosed position as explained below. FIG. 2 shows the computer system 100 in the open position. The user can respond to the prompt by rotating display member 130 in the direction indicated by arrow 136 toward base member 132 to a closed and/or predetermined position or arrangement relative to base member, display member 130 approaches base member 132 and engages button 142, thereby actuating switch 140. Actuation of switch 140 causes input signal 120 to be generated which computer system 100 uses to enable or permit the update of firmware 108. In other examples, actuation of switch 140 can cause an interrupt and/or other type of signal to be generated and/or otherwise processed via hardware, software and/or a combination thereof of computer system 100.

Thus, in operation, once computer system 100 is closed (e.g., display member 130 is brought within a predetermined arrangement, distance and/or position relative to base member 132), computer system 100 can allow the update of firmware 108 to proceed. The computer system 100 can generate an alert or prompt when firmware 108 has completed being updated. At this point, the user can place computer system 100 back to the open position by rotating the display member 130 in the direction indicated by arrow 134 away from base member 132 to an opened and/or predetermined position or arrangement relative to base member, display member 130 moving away from base member 132 and disengages button 140.

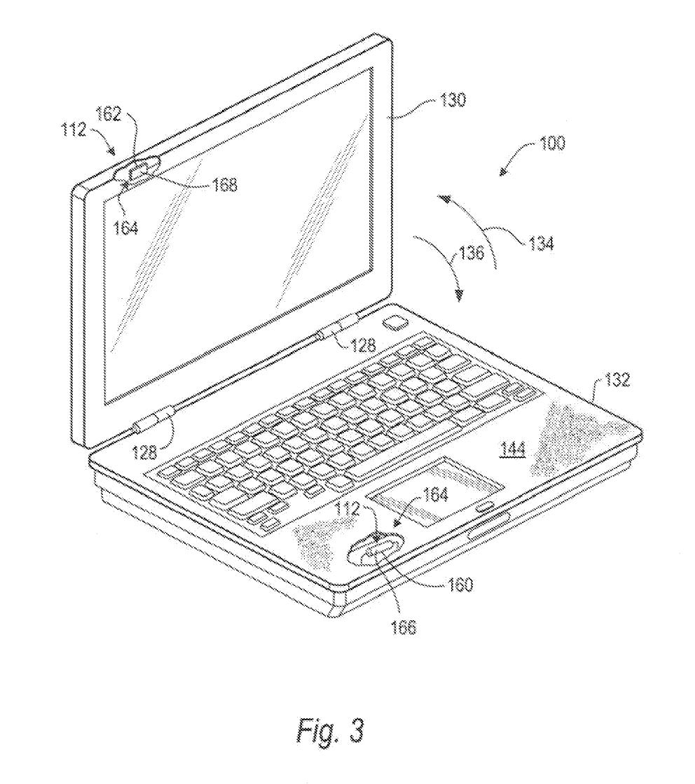

FIG. 3 shows a perspective view of another example of computer system 100 of FIG. 1. In the example illustrated in FIG. 3, computer system 100 comprises another example input sensor 112. The input sensor 112 is shown to include a switch 164 having a sensor element 166 disposed in base member 132 and a sensor element 168 disposed in display member 130. In operation, input sensor 112 can generate input signal 120 (FIG. 1) to allow computer system 100 to update firmware 108. In other examples, input sensor 112 can generate an interrupt and/or transmit a signal generated and/or otherwise processed via hardware, software and/or a combination thereof of computer system 100 to allow firmware updates in response to sensor elements 166 and 168 being positioned within a predetermined distance and/or in close proximity to each other. Computer system 100 does not generate input signal 120 when in an opened position as shown in FIG. 1. The computer system 100 generates input signal 120 when computer system is in the closed position. Accordingly, computer system 100 can be in a closed position, that is, when display member 130 is in the closed and/or in another predetermined arrangement or position relative to base member 132, computer system 100 can allow firmware updates to proceed on the computer system.

in the example illustrated in FIG. 3, sensor element 166 comprises a reed switch 160 and sensor element 168 comprises a magnet 162 such that reed switch 160 is actuated in response to a magnetic field generated by magnet 162. Accordingly, actuation of reed switch 160 causes input signal 120 to be generated to allow computer system to update firmware 108. It should also be understood that the location and/or position of reed switch 160 and magnet 162 may be otherwise reversed (e.g., reed switch 160 located in display member 130 and magnet 162 located in base member 132). Additionally, it should be understood that other types of non-mechanical sensor elements may be used in input sensor 112 for detecting the positioning of display member 130 relative to base member 132.

Although the above has described input sensor 112 in the context of a sensor that can detect the position of a display member relative to a base member, it should be understood that input sensor 112 can take other forms and functions. For example, input sensor 112 can be a biometric sensor which can receive biometric information from a user and verify the identity of the user before allowing computer system 100 to update firmware 108

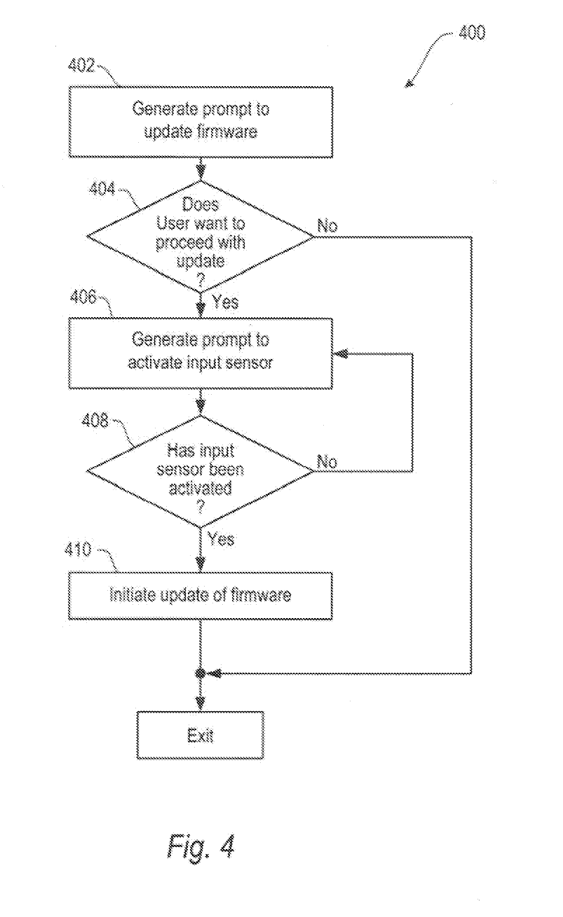

FIG. 4 is an embodiment of a flow diagram 400 illustrating a method to update firmware 108 on computer system 100. The computer system 100 can begin the method at block 402 by generating a prompt to a user to inquire whether the user desires to update firmware 108. For example, computer system 100 can execute instructions of update program 106 to generate a prompt on a display of computer system inquiring whether a user desires to update firmware 102. However, it should be understood that other means of prompting the user can be employed such as an audio indicator (e.g., sound pattern), visual indicator (e.g., light pattern) or the like.

At block 404, computer system 100 can check whether the user desires to update firmware 108 in response to the prompt. The user can respond to the prompt using any input means such as entering input through a keyboard of the computer system. If the user does not desire to proceed with an update to firmware 108, then processing can terminate by proceeding to the exit block. On the other hand, if the user desires to proceed with an update of firmware 108 then processing proceeds to block 406.

At block 406, computer system 100 can generate a prompt to the user requesting that the user activate input sensor 112 to proceed with the update of firmware 108. For example, computer system 100 can execute instructions of update program 106 to generate a prompt on a display instructing that the user place computer system 100 in the dosed position by rotating display member 130 towards base member 132.

Processing proceeds to block 408 which may include having computer system 100 check whether the user has activated input sensor 112. For example, update program 106 can check whether the user placed computer system in the closed position by checking for the occurrence of input signal 120. If input signal 120 has not been generated, then processing can proceed back to block 406 to keep checking for the generation of the input signal. A timeout period can be employed to handle a condition when the signal is not generated within the timeout period. On the other hand, if input signal 120 has been generated, then processing can proceed to block 410.

In another example, computer system 100 can initiate update of firmware without checking input signal. In this case, computer system 100 can execute instructions of update program 106 to initiate the update of firmware 108 by starting to copy or write a portion of the new firmware from the update program to firmware 108. The update program 106 can check whether the update was successful by verifying whether firmware 108 was updated by reading back the portion that was written. This example relies on using write protect logic 110 and whether input signal 120 has been generated. If input signal 120 was not generated, then write enable signal 124 is not enabled which prevents computer system 100 from performing a write operation to firmware 108. On the other hand, if input signal 120 was generated, then write enable signal 124 is enabled which allows computer system 100 to perform a write operation to firmware 108.

At block 410, computer system 100 can proceed to initiate update of firmware 108. For example, update program 106 can begin to initiate the update of firmware 108 by updating one or more portions of firmware 108 as necessary. In some examples, update program 106 can verify whether the update of firmware 108 was successful by reading back the portion that was written and comparing the two portions to each other.

The components of computer system 100 can be implemented with machine-readable instructions that are loaded for execution on processor(s). A processor can include a microprocessor, microcontroller, processor module or subsystem, programmable integrated circuit, programmable gate array, or another control or computing device.

Data and instructions can be stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

Further, the components shown and described in this application may also be implemented in program code (e.g., firmware and/or software and/or other logic instructions) stored on one or more computer readable medium and executable by one or more processors to perform the operations described in this application. The components are merely examples of various functionality that may be provided, and are not intended to be limiting. The embodiments shown and described are provided for purposes of illustration and are not intended to be limiting.

1. A computer system comprising:
a input sensor to provide a signal;
a firmware storage medium; and
a processor to execute instructions of an update program if the signal is provided from the input sensor to initiate update of firmware on the firmware storage medium, wherein the processor does not provide the signal from execution of the instructions of the update program.

2. The computer system of claim 1, wherein the processor is configured to execute instructions of the update program to check whether the signal is provided by the input sensor before the processor initiates update of the firmware on the firmware storage medium.

3. The computer system of claim 1, wherein the processor is configured to execute instructions of the update program to initiate update of the firmware on the firmware storage medium without checking whether the signal is provided by the input sensor.

4. The computer system of claim 1, wherein the processor is configured to execute instructions of the update program to verify whether at least a portion of the firmware was updated on the firmware storage medium after the processor initiated update of the firmware on the firmware storage medium.

5. The computer system of claim 1, further comprising a display member coupled to a base member to enable variable positioning of the display member relative to the base member; and wherein the input sensor is configured to generate an input signal based on a position of the display member relative to the base member.

6. The computer system of claim 1, wherein the processor is configured to execute instructions of the update program to provide a user prompt for activation of the input sensor.

7. The computer system of claim 1, wherein the firmware storage medium comprises non-volatile memory.

8. The computer system of claim 1, wherein the firmware comprises instructions that include a basic input output system (BIOS).

9. A method of a processor executing instructions of an update program to update firmware on firmware storage medium of a computer system, the method comprising:
receiving an input signal from an input sensor;
determining whether the input signal is from the input sensor and not from execution of instructions of the update program by the processor of the computer system; and
executing instructions of the update program by the processor to initiate update of the firmware on the firmware storage of the computer system if it is determined that the input signal is from the input sensor and not from execution of instructions of the update program.

10. The method of claim 9, further comprising the processor executing instructions of the update program for providing a prompt to activate the input sensor.

11. The method of claim 9, further comprising the processor executing instructions of the update program for checking whether the signal is provided by the input sensor before the processor initiates update of the firmware on the firmware storage.

12. The method of claim 9, further comprising the processor executing instructions of the update program for initiating update of the firmware on the firmware storage without checking whether the signal is provided by the input sensor.

13. An article comprising at least one computer-readable storage medium storing instructions of an update program that upon execution by a processor cause a computer system to:
determine whether a signal from an input sensor is generated by execution of instructions of the update program by the processor; and
initiate update of firmware on a firmware storage medium of the computer system if it is determined that the input signal is from the input sensor but not from execution of instructions of the update program.

14. The article of claim 13, further comprising executing instructions of the update program that cause the computer system to provide a prompt to activate the input sensor.

15. The article of claim 13, further comprising executing instructions of the update program that cause the computer system to check whether the signal is provided by the input sensor before the processor initiates update of the firmware on the firmware storage.
